(19) United States
(12) Patent Application Publication
(10) Pub. No.: US 2026/0227016 A1
(43) Pub. Date: Aug. 6, 2026

(54) FLUID CONNECTION ASSEMBLY WITH RETAINER INCLUDING OVERMOLDED SEAL

(71) Applicant: Oetiker NY, Inc., Lancaster, NY (US)

(72) Inventors: Kimberly Romus, Lancaster, NY (US); Andrew Jon Crane, Lockport, NY (US)

(21) Appl. No.: 19/154,433

(22) PCT Filed: Feb. 26, 2024
(86) PCT No.: PCT/US2024/017210

§ 371 Date: Aug. 7, 2025

Related U.S. Application Data
(60) Provisional application No. 63/488,487, filed on Mar. 4, 2023.

(51) Int. Cl. F16L 37/098; F16L 21/04

(52) U.S. Cl. CPC F16L 37/0985; F16L 21/04

(57) ABSTRACT

The fluid connection assembly comprises a connector body, including a first end, a second end, a first through-bore, a first radially inward facing surface including a groove, and a first radially outward facing surface, and a retainer removably connectable to the connector body, including a second radially inward facing surface forming a third end and a fourth end, a second radially outward facing surface, a plurality of apertures extending radially from the second radially inward facing surface to the second radially outward facing surface, and at least one finger extending from the fourth end, and a seal overmolded onto the retainer.

### CROSS-REFERENCE TO RELATED APPLICATION

This application claims the benefit under Articles 4 and 8 of the Stockholm Act of the Paris Convention for the Protection of Industrial Property of U.S. Patent Application No. 63/488,487, filed on Mar. 4, 2023, which application is hereby incorporated by reference herein in its entirety.

### FIELD

The present disclosure relates to fluid connectors, and more particularly, to a fluid connection assembly including a retainer that decreases the insertion force required for assembly and allows for quick assembly of components without the need for tools.

### BACKGROUND

Fluid connectors, fluid connections, and fluid connection assemblies are integral components for many applications, and especially for automotive applications. Since an automotive system is made up of various components such as a radiator, transmission, engine, and refrigeration or coolant system, fluid must be able to travel not only within each component but also between components. An example of fluid traveling between components is the transmission fluid traveling from the transmission to the transmission oil cooler in order to lower the temperature of the transmission fluid. Fluid predominantly moves between components via flexible or rigid hoses which connect to each component by fluid connectors. Such fluid connectors typically include a retaining clip, retaining ring clip, or snap ring carried on the connector body which is adapted to snap behind a raised shoulder of a tube when the tube is fully inserted into the connector body.

However, there are many drawbacks with current designs. Current fluid connection designs require slots or apertures to be machined in the connector body such that the retaining clip can protrude therethrough and engage the tube, which requires extra post-process manufacturing. During the assembly process, installation of the retaining clip onto the connector body is difficult and failure to install the retaining clip properly can jeopardize the structural integrity of the retaining clip. The force required to engage the tube into the connector body, and overcome the radial force of the retaining clip, is very large with current designs. Since the retaining clips are very thin and small, it is easy to lose them if dropped or misplaced. Some connection assembly solutions take a long time to secure and require tools for the assembly process. An additional issue with current designs is the need to machine or form annular grooves within the connector body such that seals may be arranged therein.

Thus, there has been a long-felt need for a fluid connection assembly including a connector body and a retainer that allows for quick assembly and disassembly, eliminates the need for post-process machining, and reduces the insertion force required to assemble the fluid connector.

### SUMMARY

The present disclosure is directed to one or more exemplary embodiments of a fluid connection assembly.

In an exemplary embodiment, the fluid connection assembly comprises a connector body, including a first end, a second end, a first through-bore, a first radially inward facing surface including a groove, and a first radially outward facing surface, and a retainer removably connectable to the connector body, including a second radially inward facing surface forming a third end and a fourth end, a second radially outward facing surface, a plurality of apertures extending radially from the second radially inward facing surface to the second radially outward facing surface, and at least one finger extending from the fourth end, and a seal overmolded onto the retainer.

In an exemplary embodiment, the apertures are circumferentially spaced. In an exemplary embodiment, the seal extends through the plurality of apertures, protrudes radially outward from the second radially outward facing surface, and protrudes radially inward from the second radially inward facing surface. In an exemplary embodiment, the seal creates a fluid tight connection between the retainer and the connector body. In an exemplary embodiment, the seal wraps around the third end. In an exemplary embodiment, the seal is arranged axially spaced apart from the third end. In an exemplary embodiment, the at least one finger comprises a plurality of fingers circumferentially spaced.

In an exemplary embodiment, the at least one finger comprises a third radially outward facing surface, a third radially inward facing surface, and a through-hole extending radially from the third radially inward facing surface to the third radially outward facing surface. In an exemplary embodiment, a tongue is arranged in the through-hole. In an exemplary embodiment, the tongue forms a shoulder protruding radially outward from the third radially outward facing surface, the shoulder operatively arranged to engage the groove to secure the retainer to the connector body. In an exemplary embodiment, the tongue protrudes radially inward from the third radially inward facing surface. In an exemplary embodiment, the third radially outward facing surface comprises a constant diameter. In an exemplary embodiment, the third radially outward facing surface is frusto-conical.

In an exemplary embodiment, the at least one finger further comprises an arm extending radially outward from the third radially outward facing surface, and a projection extending axially from the arm and forming a channel between the projection and the third radially outward facing surface. In an exemplary embodiment, the channel is operatively arranged to engage the second end.

The present disclosure is directed to one or more exemplary embodiments of a fluid connection assembly.

In an exemplary embodiment, the fluid connection assembly comprises a connector body, including a first end, a second end, a first through-bore, a first radially inward facing surface including a groove, and a first radially outward facing surface, and a retainer removably connectable to the connector body, including a second radially inward facing surface forming a third end and a fourth end, a second radially outward facing surface, a plurality of apertures extending radially from the second radially inward facing surface to the second radially outward facing surface, and at least one finger extending from the fourth end, and a seal overmolded onto the retainer to create a fluid tight connection between the retainer and the connector body, wherein the seal extends through the plurality of apertures, protrudes radially outward from the second radially outward facing surface, and protrudes radially inward from the second radially inward facing surface.

In an exemplary embodiment, the at least one finger comprises a third radially outward facing surface, a third radially inward facing surface, and a through-hole extending radially from the third radially inward facing surface to the third radially outward facing surface. In an exemplary embodiment, a tongue is arranged in the through-hole. In an exemplary embodiment, the tongue forms a shoulder protruding radially outward from the third radially outward facing surface, the shoulder operatively arranged to engage the groove to secure the retainer to the connector body. In an exemplary embodiment, the tongue comprises a frusto-conical surface that protrudes radially inward from the third radially inward facing surface.

The present disclosure is directed to one or more exemplary embodiments of a fluid connection assembly.

In an exemplary embodiment, the fluid connection assembly may comprise a connector body and a retainer, wherein the retainer comprises a seal integrated therein. When connected to the connector body, the retainer is capable of retaining a tube for the purpose of flowing fluid. In an exemplary embodiment, the seal is overmolded into the retainer such that is creates a seal between the retainer and the connector body, and also a seal between the retainer and the tube. This arrangement eliminates the need for separate components for the seal and the retaining feature and reduces post-process machining of the connector body. In an exemplary embodiment, the retainer comprises plastic. In an exemplary embodiment, the retainer comprises radially extending through-holes that allow for the seal elastomer to flow and bond between the inside and outside of the retainer.

In an exemplary embodiment, in a first assembly method, the retainer can be installed in the connector body and subsequently, the tube is installed in the retainer and connector body. In an exemplary embodiment, in a second assembly method, the retainer is arranged on the tube first, and then the tube and retainer assembly can be installed into the connector body.

These and other objects, features, and advantages of the present disclosure will become readily apparent upon a review of the following detailed description of the disclosure, in view of the drawings and appended claims.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure, in which corresponding reference symbols indicate corresponding parts. However, the drawings do not illustrate all possible implementations of the presently disclosed subject matter and are not intended to limit the scope of the present disclosure in any way.

FIG. 1 is a front perspective view of a fluid connection assembly.

FIG. 2 is a front perspective exploded view of the fluid connection assembly shown in FIG. 1.

FIG. 3A is a rear perspective view of the retainer shown in FIG. 1A with the seal removed.

FIG. 3B is a rear perspective view of the retainer shown in FIG. 1A with the seal overmolded thereon.

FIG. 4 is a cross-sectional view of the fluid connection assembly taken generally along line 4-4 in FIG. 1.

FIG. 5A is a rear perspective view of an embodiment of a retainer with the seal removed.

FIG. 5B is a rear perspective view of the retainer shown in FIG. 5A with the seal overmolded thereon.

FIG. 6A is a rear perspective view of an embodiment of a retainer with the seal removed.

FIG. 6B is a rear perspective view of the retainer shown in FIG. 6A with the seal overmolded thereon.

FIG. 7A is a front perspective view of a disconnect tool for the fluid connection assembly shown in FIG. 1.

FIG. 7B is a rear perspective view of the disconnect tool shown in FIG. 7A.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

Where used herein, the terms “first,” “second,” and so on, do not necessarily denote any ordinal, sequential, or priority relation, but are simply used to more clearly distinguish one element or set of elements from another, unless specified otherwise.

Where used herein, the term “about” when applied to a value is intended to mean within the tolerance range of the equipment used to produce the value, or, in some examples, is intended to mean plus or minus 10%, or plus or minus 5%, or plus or minus 1%, unless otherwise expressly specified.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “substantially” is intended to mean values within ten percent of the specified value.

Where used herein, the term “exemplary” is intended to mean “an example of,” “serving as an example,” or “illustrative,” and does not denote any preference or requirement with respect to a disclosed aspect or embodiment.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element. A similar interpretation is intended when the phrase “used in at least one of:” is used herein.

It should be appreciated that the term “tube” as used herein is synonymous with hose, pipe, channel, conduit, tube end form, or any other suitable pipe flow used in hydraulics and fluid mechanics. It should further be appreciated that the term “tube” can mean a rigid or flexible conduit of any material suitable for containing and allowing the flow of a gas or a liquid.

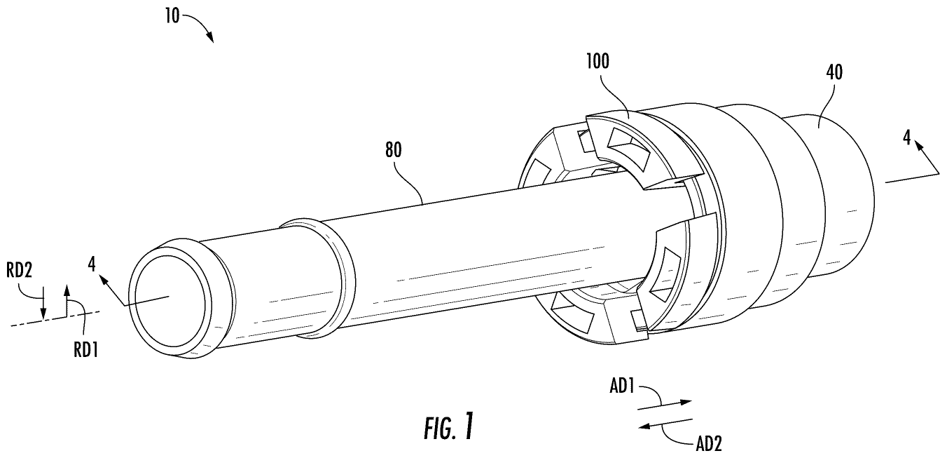

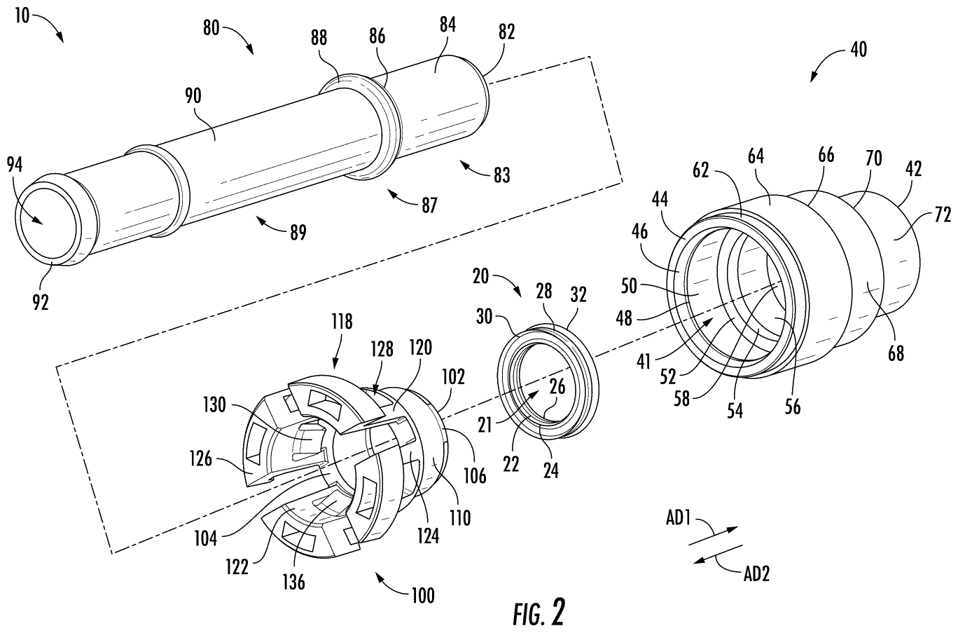

Adverting now to the figures, FIG. 1 is a front perspective view of fluid connection assembly 10. FIG. 2 is a front perspective exploded view of fluid connection assembly 10. Fluid connection assembly 10 generally comprises connector body 40 and retainer 100. In an exemplary embodiment, fluid connection assembly 10 further comprises tube 80.

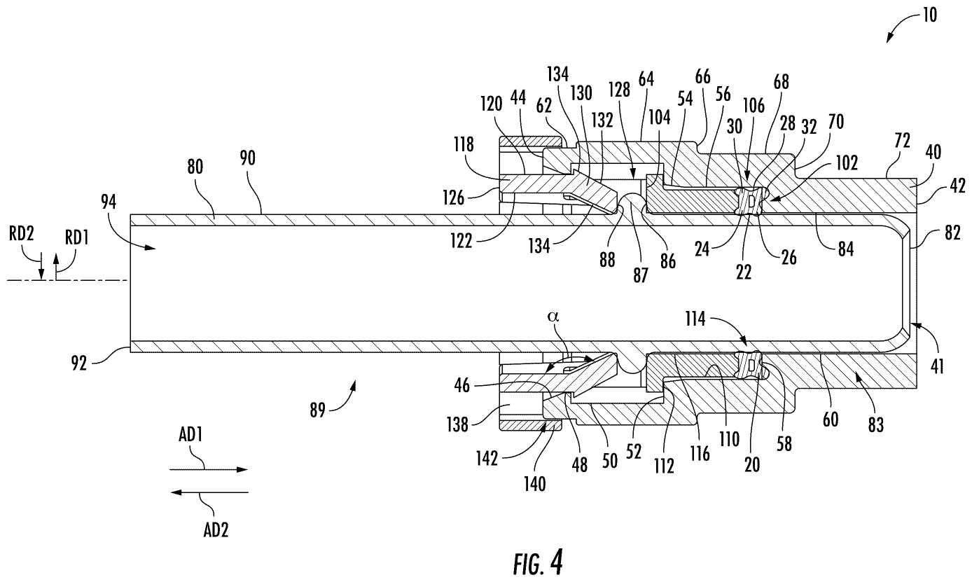

Tube 80 comprises end 82, section 83, bead or shoulder 87, section 89, end 92, and through-bore 94. Through-bore 94 extends through tube 80 from end 82 to end 92. Section 83 is arranged between end 82 and shoulder 87 and comprises radially outward facing surface 84. Radially outward facing surface 84 includes a substantially constant diameter. In an exemplary embodiment, radially outward facing surface 84 comprises a frusto-conical taper or curvilinear surface proximate end 82 (see FIG. 4).

Shoulder 87 is arranged between section 83 and section 89 and comprises surface 86 and surface 88. In an exemplary embodiment, surface 86 is an axial surface facing at least partially in axial direction AD1 and surface 88 is an axial surface facing at least partially in axial direction AD2. In an exemplary embodiment, surface 86 is a frusto-conical surface extending from the radially outward facing surface of shoulder 87 radially inward in axial direction AD1. For example, surface 86 may be a linear conical shape increasing in diameter in axial direction AD2. In an exemplary embodiment, surface 86 may comprise a linear portion and a conical or frusto-conical portion. Shoulder 87 comprises a radially outward facing surface. In an exemplary embodiment, the radially outward facing surface of shoulder 87 comprises a constant diameter. In an exemplary embodiment, the radially outward facing surface of shoulder 87 comprises a variable diameter. Section 89 is arranged between shoulder 87 and end 92 and comprises radially outward facing surface 90. Radially outward facing surface 90 includes a substantially constant diameter.

Tube 80 is arranged to be inserted, specifically with end 82 first, into connector body 40. Tube 80 is inserted into connector body 40 until section 83, or radially outward facing surface 84, engages radially inward facing surface 60 and retainer 100, 200, 300 snaps over shoulder 87. Seal 20 arranged on retainer 100, 200, 300 sealingly engages radially outward facing surface 84 and forms a fluid-tight seal between tube 80 and retainer 100, 200, 300 (see FIG. 4). It should be appreciated that tube 80 may be any traditional tube or tube end form comprising a bead, radially outward extending protrusion or flange, or ramp profile, which extends radially outward and axially on the outer surface of the tube, to secure the tube within the connector body. In an exemplary embodiment, tube 80 comprises a metal. In an exemplary embodiment, tube 80 comprises a polymer. In an exemplary embodiment, tube 80 comprises a ceramic.

Connector body 40 comprises end 42, end 44, through-bore 41 extending from end 42 to end 44, one or more radially inward facing surfaces, for example, radially inward facing surface 48, radially inward facing surface 56, and radially inward facing surface 60, and one or more radially outward facing surfaces, for example, radially outward facing surface 62, radially outward facing surface 64, radially outward facing surface 68, and radially outward facing surface 72. Radially inward facing surface 48 extends from end 44 in axial direction AD1. In an exemplary embodiment, radially inward facing surface 48 comprises a constant diameter. Radially inward facing surface 48 comprises annular groove 50 forming a radially inward facing surface and two axial surfaces. Annular groove 50, and in particular the axial surface of annular groove 50 facing in axial direction AD1, is arranged to engage raised ledges on the fingers of retainer 100, 200, 300 to secure retainer 100, 200, 300 in connector body 40, as will be described in greater detail below. In an exemplary embodiment, radially inward facing surface 48 is connected to end 44 via radially inward facing surface 46. Radially inward facing surface 46 is a frusto-conical surface extending radially outward in axial direction AD2. Radially inward facing surface 46 facilitates alignment and connection of retainer 100, 200, 300 as it is being connected to connector body 40.

Radially inward facing surface 48 is connected to radially inward facing surface 46 via surface 52. Surface 52 is an axial surface facing substantially in axial direction AD2. In an exemplary embodiment, radially inward facing surface 56 is connected to axial surface 52 via radially inward facing surface 54. Radially inward facing surface 54 is a frusto-conical surface extending radially outward in axial direction AD2. Radially inward facing surface 54 facilitates alignment and connection of retainer 100, 200, 300 as it is being connected to connector body 40. Radially inward facing surface 56 is connected to radially inward facing surface 60 via surface 58. Surface 58 is an axial surface facing substantially in axial direction AD2. Radially inward facing surface 60 extends from end 42. In an exemplary embodiment, radially inward facing surface 56 has a greater diameter than the diameter of radially inward facing surface 60. In an exemplary embodiment, radially inward facing surface 48 has a greater diameter than the diameter of radially inward facing surface 56. In an exemplary embodiment, radially inward facing surface 50 has a diameter that is greater than the diameter of radially inward facing surface 48. It should be appreciated that the various radially inward facing surfaces may comprise constant diameters or variable diameters.

Radially outward facing surface 72 extends from end 42. Radially outward facing surface 68 is connected to radially outward facing surface 72 via surface 70. In an exemplary embodiment, surface 70 is an axial facing surface extending substantially in axial direction AD1. Radially outward facing surface 64 is connected to radially outward facing surface 68 via surface 66. In an exemplary embodiment, surface 66 is an axial surface facing substantially in axial direction AD1. Radially outward facing surface 62 extends from end 44. In an exemplary embodiment, radially outward facing surface 62 is connected to radially outward facing surface 64 via an axial surface facing substantially in axial direction AD2. In an exemplary embodiment, radially outward facing surface 68 has a greater diameter than the diameter of radially outward facing surface 72. In an exemplary embodiment, radially outward facing surface 62 has a diameter greater than the diameter of radially outward facing surface 68. In an exemplary embodiment, radially outward facing surface 64 has a greater diameter than the diameter of radially outward facing surface 62. It should be appreciated that the various radially outward facing surfaces may comprise constant diameters or variable diameters.

Connector body 40 is arranged to be connected to a component that is filled with a fluid. For example, connector body 40 may be connected to a transmission via radially outward facing surface 72 (e.g., via threading, brazing, adhesives, welding, etc.). Connector body 40 may be screwed into a threaded hole in the transmission via a head (e.g., using a wrench), which is then filled with transmission fluid. In an exemplary embodiment, such head is hexagonal; however, it should be appreciated that the head may comprise any geometry suitable for applying torque to connector body 40. It should also be noted that, in an exemplary embodiment, connector body 40 may also be used for an inline connection within a line set. Another component in which fluid connection assembly 10, specifically connector body 40, may be installed into is an engine block. It should be appreciated that fluid connection assembly 10 may be used in various other components, assemblies, and subassemblies in which fluid connection is desired. In an exemplary embodiment, connector body 40 comprises a metal. In an exemplary embodiment, connector body 40 comprises a polymer. In an exemplary embodiment, connector body 40 comprises a ceramic.

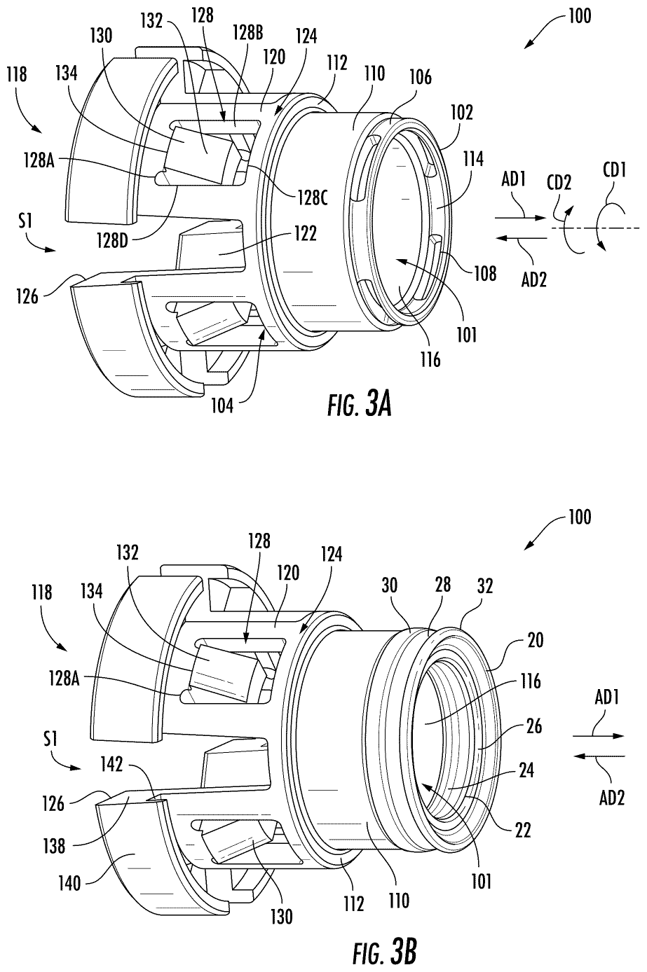

FIG. 3A is a rear perspective view of retainer 100 with seal 20 removed. FIG. 3B is a rear perspective view of retainer 100 with seal 20 overmolded thereon. Retainer 100 comprises through-bore 101, end 102, end or surface 104, radially outward facing surface 106, radially outward facing surface 110, radially inward facing surface 114, radially inward facing surface 116, and one or more fingers 118. Radially outward facing surface 106 forms end 102 and comprises one or more apertures 108. Apertures 108 are operatively arranged for overmolded seal 20, as will be described in greater detail below. Radially outward facing surface 110 is connected to radially inward facing surface 106 and extends therefrom in axial direction AD2. In an exemplary embodiment, the diameter of radially outward facing surface 106 is less than the diameter of radially outward facing surface 110. Radially inward facing surface 114 forms end 102. Apertures 108 extend from radially outward facing surface 106 to radially inward facing surface 114. Radially inward facing surface 116 is connected to radially inward facing surface 114 and extends therefrom in axial direction AD2. In an exemplary embodiment, the diameter of radially inward facing surface 114 is less than the diameter of radially inward facing surface 116.

Fingers 118 generally extend from end 104 and form radially outward facing surface 120 and radially inward facing surface 122. Radially outward facing surface 120 is connected to radially outward facing surface 110 and extends therefrom in axial direction AD2. In an exemplary embodiment, the diameter of radially outward facing surface 120 is greater than the diameter of radially outward facing surface 110. In such exemplary embodiment, and as shown, radially outward facing surface 120 is connected to radially outward facing surface 110 by surface 112. Surface 112 is an axial surface facing generally in direction AD1. In an exemplary embodiment, radially outward facing surface 120 comprises a constant diameter. In an exemplary embodiment, radially outward facing surface 120 comprises a variable diameter. For example, radially outward facing surface 120 may be a frusto-conical surface increasing in diameter in axial direction AD2. In an exemplary embodiment, the diameter of radially inward facing surface 122 is greater than the diameter of radially inward facing surface 116.

Fingers 118 further comprise end 124 and end 126. In such embodiments wherein retainer 100 comprises a plurality of fingers 118, fingers 118 are separated by circumferential spaces S1. Fingers 118 further comprise aperture 128 extending radially completely therethrough from radially outward facing surface 120 to radially inward facing surface 122. Aperture 128 forms one or more surfaces, for example surfaces 128A-128D. In an exemplary embodiment, surface 128A faces in axial direction AD1, surface 128C faces in axial direction AD2, surface 128B faces in circumferential direction CD1, and surface 128D faces in circumferential direction CD2. Tab or tongue 130 is arranged in aperture 128 such that it is fixedly secured at one end but spaced apart within aperture 128. For example, tongue 130 is fixedly secured to surface 128A but otherwise spaced apart from surfaces 128B-128D. This allows tongue 130 to pivot with respect to radially outward facing surface 120 in radial direction RD1 and radial direction RD2.

Tongue 130 comprises radially outward facing surface 132 and radially inward facing surface 134. In a rest or non-deformed position, radially outward facing surface 132 protrudes radially outward from radially outward facing surface 120 forming shoulder 134. Shoulder 134 faces substantially in axial direction AD2. Shoulder 134 is operatively arranged to engage groove 50 to connect retainer 100 to connector body 40, as will be described in greater detail below. In the non-deformed position, radially inward facing surface 134 extends radially inward from radially inward facing surface 122. As best shown in FIG. 4, in the non-deformed position radially inward facing surface 134 is arranged at angle α with respect to radially inward facing surface 122. In an exemplary embodiment, angle α is an obtuse angle. In an exemplary embodiment, radially outward facing surface 132 is parallel to radially inward facing surface 134. In an exemplary embodiment, radially outward facing surface 132 is nonparallel to radially inward facing surface 134.

When retainer 100 is arranged in connector body 40 without tube 80, tongue 130 can be deformed radially inward in radial direction RD1 to disengage shoulder 134 from groove 50 such that retainer 100 can be removed from connector body 40. When retainer 100 and tube 80 are secured in connector body, tongue 130 can be deformed radially outward in radial direction RD2 to disengage shoulder 87 such that tube 80 can be removed from retainer 100. Retainer 100 can then be removed from connector body 40.

Seal 20 comprises an elastomer (e.g., rubber) and is overmolded onto retainer 100. By overmolded it is meant that the elastomer in a substantially liquid form is molded over connector body 40, at which point the elastomer solidifies and forms seal 20. In an exemplary embodiment, the elastomer is injection molded onto radially outward facing surface 106 and radially inward facing surface 114 such that it engages apertures 108. When the elastomer solidifies, seal 20 comprises radially inward facing surface 22 arranged radially inward of radially inward facing surface 116 and radially outward facing surface 28 arranged radially outward of radially outward facing surface 110. This allows seal 20 to perform sealing on two radial sides of retainer 100. For example, overmolded seal 20 facilitates a sealed connection between retainer 100 and connector body 40, and also between retainer 100 and tube 80. As such, overmolded seal 20 also creates a direct seal between tube 80 and connector body 40. In an exemplary embodiment, and as shown, seal 20 wraps around end 102.

In an exemplary embodiment, radially inward facing surface 22 comprises one or more radially inward extending lobes or protrusions, for example protrusions 24 and 26. Protrusions 24 and 26 may be spaced apart axially and are arranged to provide a better seal between retainer 100 and tube 80. In an exemplary embodiment, radially outward facing surface 28 comprises one or more radially outward extending lobes or protrusions, for example protrusions 30 and 32. Protrusions 30 and 32 may be spaced apart axially and are arranged to provide a better seal between retainer 100 and connector body 40. It should be appreciated that, in the solid state, seal 20 engages apertures 108 and forms a seal on radially outward facing surface 110 and radially inward facing surface 116.

In an exemplary embodiment, fingers 118 further comprise arm 138 and projection 140. Arm 138 is arranged at or proximate to end 126 and extends radially outward in radial direction RD1 from radially outward facing surface 120. Projection 140 extends from arm 138 in axial direction AD1 and forms channel 142 arranged radially between projection 140 and radially outward facing surface 120. Channel 142 engages end 44 to provide added stability and secure the connection between retainer 100 and connector body 40. In particular, projection 140 engages radially outward facing surface 62.

FIG. 4 is a cross-sectional view of fluid connection assembly 10 taken generally along line 4-4 in FIG. 1. To assemble fluid connection assembly 10, retainer 100 is inserted into connector body 40 in axial direction AD1 with end 102 first. Due to the frusto-conical arrangement of tongues 130, as radially outward facing surfaces 132 engage radially inward facing surface 46 tongues 130 deflect radially inward in radial direction RD2. Once shoulders 134 are aligned with groove 50, tongues 130 displace radially outward in radial direction RD1 to their original non-deflected position. When retainer 100 is secured in connector body 40, seal 20 engages surface 58 and radially inward facing surface 56 providing a fluid tight connection between retainer 100 and connector body 40, radially outward facing surface 110 is engaged with radially inward facing surface 56, surface 112 is engaged with surface 52, shoulder 134 is engaged with groove 50, and radially outward facing surface 120 is engaged with radially inward facing surface 48.

Tube 80 is inserted into retainer 100 in axial direction AD1 with end 82 first. Shoulder 87 forces tongues 130 radially outward in radial direction RD1 (i.e., increasing angle α). Once shoulder 87 axially clears tongues 130, tongues 130 deflect back to their original position and engage surface 88. Shoulder 87 is then arranged axially between tongues 130 and surface 104, thereby securing tube 80 in retainer 100 and connector body 40. Radially outward facing surface 84 engages radially inward facing surface 60 and radially inward facing surface 116, and seal 20 engages radially outward facing surface 84 thereby creating a fluid tight seal between retainer 100 and tube 80.

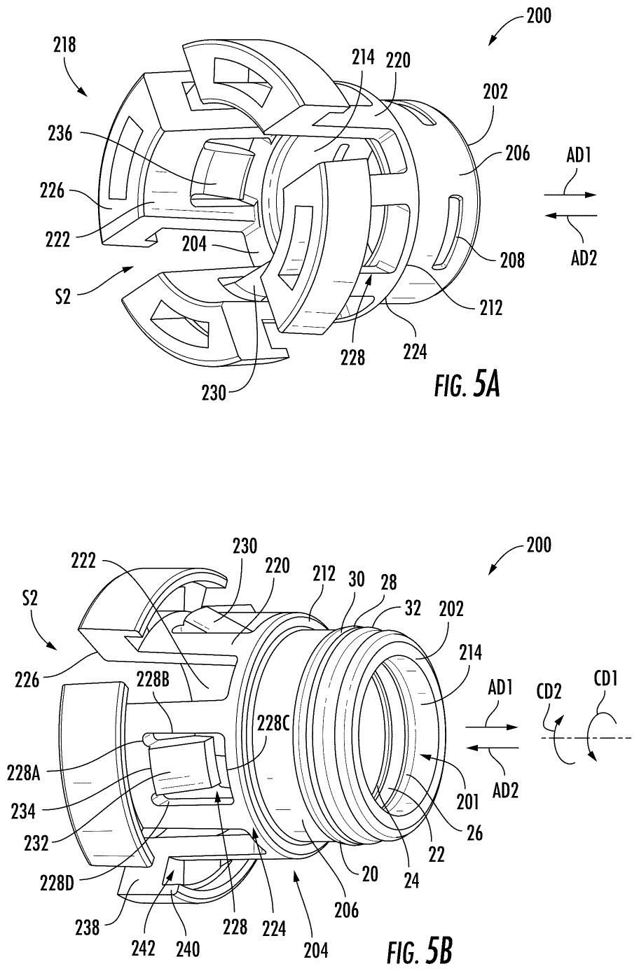

FIG. 5A is a rear perspective view of retainer 200 with seal 20 removed. FIG. 5B is a rear perspective view of retainer 200 with seal 20 overmolded thereon. Retainer 200 comprises through-bore 201, end 202, end or surface 204, radially outward facing surface 206, radially inward facing surface 214, and one or more fingers 218. Radially outward facing surface 206 forms end 202 and comprises one or more apertures 208. Apertures 208 are operatively arranged for overmolded seal 20, as will be described in greater detail below. Radially inward facing surface 214 forms end 202. Apertures 208 extend from radially outward facing surface 206 to radially inward facing surface 214.

Fingers 218 generally extend from end 204 and form radially outward facing surface 220 and radially inward facing surface 222. Radially outward facing surface 220 is connected to radially outward facing surface 206 and extends therefrom in axial direction AD2. In an exemplary embodiment, the diameter of radially outward facing surface 220 is greater than the diameter of radially outward facing surface 206. In such exemplary embodiment, and as shown, radially outward facing surface 220 is connected to radially outward facing surface 206 by surface 212. Surface 212 is an axial surface facing generally in direction AD1. In an exemplary embodiment, radially outward facing surface 220 comprises a constant diameter. In an exemplary embodiment, radially outward facing surface 220 comprises a variable diameter. For example, radially outward facing surface 220 may be a frusto-conical surface increasing in diameter in axial direction AD2. In an exemplary embodiment, the diameter of radially inward facing surface 222 is greater than the diameter of radially inward facing surface 214.

Fingers 218 further comprise end 224 and end 226. In such embodiments wherein retainer 200 comprises a plurality of fingers 218, fingers 218 are separated by circumferential spaces S2. Fingers 218 further comprise aperture 228 extending radially completely therethrough from radially outward facing surface 220 to radially inward facing surface 222. Aperture 228 forms one or more surfaces, for example surfaces 228A-228D. In an exemplary embodiment, surface 228A faces in axial direction AD1, surface 228C faces in axial direction AD2, surface 228B faces in circumferential direction CD1, and surface 228D faces in circumferential direction CD2. Tab or tongue 230 is arranged in aperture 228 such that it is fixedly secured at one end but spaced apart within aperture 228. For example, tongue 230 is fixedly secured to surface 228A but otherwise spaced apart from surfaces 228B-228D. This allows tongue 230 to pivot with respect to radially outward facing surface 220 in radial direction RD1 and radial direction RD2.

Tongue 230 comprises radially outward facing surface 230 and radially inward facing surface 234. In a rest or non-deformed position, radially outward facing surface 232 protrudes radially outward from radially outward facing surface 220 forming shoulder 234. Shoulder 234 faces substantially in axial direction AD2. Shoulder 234 is operatively arranged to engage groove 50 to connect retainer 200 to connector body 40, as will be described in greater detail below. In the non-deformed position, radially inward facing surface 234 extends radially inward from radially inward facing surface 222. In the non-deformed position, radially inward facing surface 234 is arranged at angle α (like retainer 100 shown in FIG. 4) with respect to radially inward facing surface 222. In an exemplary embodiment, angle α is an obtuse angle. In an exemplary embodiment, radially outward facing surface 232 is parallel to radially inward facing surface 234. In an exemplary embodiment, radially outward facing surface 232 is nonparallel to radially inward facing surface 234.

When retainer 200 is arranged in connector body 40 without tube 80, tongue 230 can be deformed radially inward in radial direction RD1 to disengage shoulder 234 from groove 50 such that retainer 200 can be removed from connector body 40. When retainer 200 and tube 80 are secured in connector body, tongue 230 can be deformed radially outward in radial direction RD2 to disengage shoulder 87 such that tube 80 can be removed from retainer 200. Retainer 200 can then be removed from connector body 40.

Seal 20 is overmolded onto retainer 200. In an exemplary embodiment, the elastomer is injection molded onto radially outward facing surface 206 and radially inward facing surface 214 such that it engages apertures 208. When the elastomer solidifies, seal 20 comprises radially inward facing surface 22 arranged radially inward of radially inward facing surface 214 and radially outward facing surface 28 arranged radially outward of radially outward facing surface 206. This allows seal 20 to perform sealing on two radial sides of retainer 200. For example, overmolded seal 20 facilitates a sealed connection between retainer 200 and connector body 40, and also between retainer 200 and tube 80. As such, overmolded seal 20 also creates a direct seal between tube 80 and connector body 40. In an exemplary embodiment, and as shown, seal 20 is arranged spaced apart from end 202 in axial direction AD2.

In an exemplary embodiment, fingers 218 further comprise arm 238 and projection 240. Arm 238 is arranged at or proximate to end 226 and extends radially outward in radial direction RD1 from radially outward facing surface 220. Projection 240 extends from arm 238 in axial direction AD1 and forms channel 242 arranged radially between projection 240 and radially outward facing surface 220. Channel 242 engages end 44 to provide added stability and secure the connection between retainer 200 and connector body 40. In particular, projection 240 engages radially outward facing surface 62.

To assemble the fluid connection assembly, retainer 200 is inserted into connector body 40 in axial direction AD1 with end 202 first. Due to the frusto-conical arrangement of tongues 230, as radially outward facing surfaces 232 engage radially inward facing surface 46 tongues 230 deflect radially inward in radial direction RD2. Once shoulders 234 are aligned with groove 50, tongues 230 displace radially outward in radial direction RD1 to their original non-deflected position. When retainer 200 is secured in connector body 40, seal 20 engages radially inward facing surface 56 providing a fluid tight connection between retainer 200 and connector body 40, radially outward facing surface 210 is engaged with radially inward facing surface 56, surface 212 is engaged with surface 52, shoulder 234 is engaged with groove 50, and radially outward facing surface 220 is engaged with radially inward facing surface 48.

Tube 80 is inserted into retainer 200 in axial direction AD1 with end 82 first. Shoulder 87 forces tongues 230 radially outward in radial direction RD1 (i.e., increasing angle α). Once shoulder 87 axially clears tongues 230, tongues 230 deflect back to their original position and engage surface 88. Shoulder 87 is then arranged axially between tongues 230 and surface 204, thereby securing tube 80 in retainer 200 and connector body 40. Radially outward facing surface 84 engages radially inward facing surface 60 and radially inward facing surface 216, and seal 20 engages radially outward facing surface 84 thereby creating a fluid tight seal between retainer 200 and tube 80.

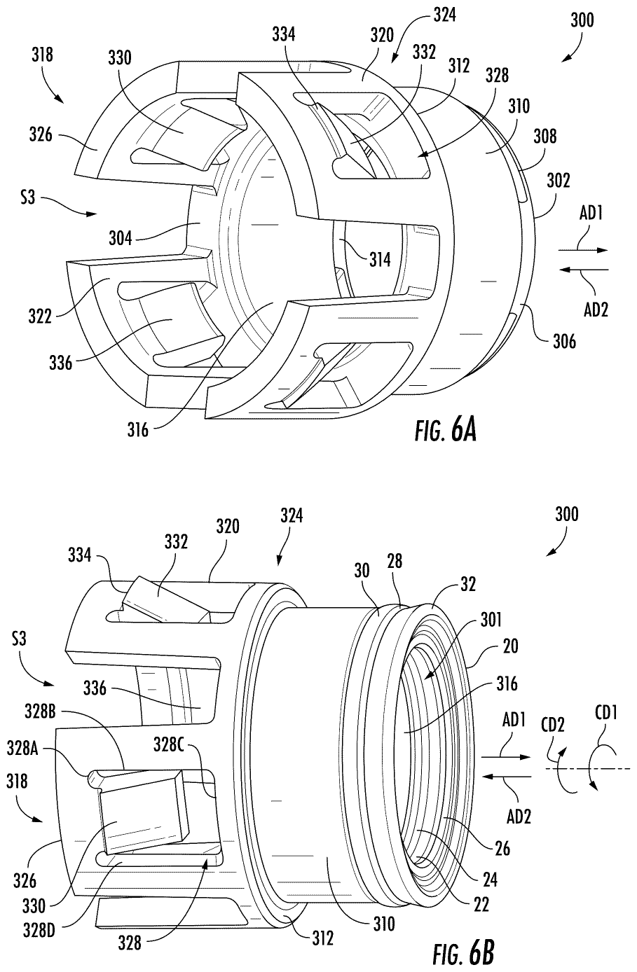

FIG. 6A is a rear perspective view of retainer 300 with seal 20 removed. FIG. 6B is a rear perspective view of retainer 300 with seal 20 overmolded thereon. Retainer 300 comprises through-bore 301, end 302, end or surface 304, radially outward facing surface 306, radially outward facing surface 310, radially inward facing surface 314, radially inward facing surface 316, and one or more fingers 318. Radially outward facing surface 306 forms end 302 and comprises one or more apertures 308. Apertures 308 are operatively arranged for overmolded seal 20, as will be described in greater detail below. Radially outward facing surface 310 is connected to radially inward facing surface 306 and extends therefrom in axial direction AD2. In an exemplary embodiment, the diameter of radially outward facing surface 306 is less than the diameter of radially outward facing surface 310. Radially inward facing surface 314 forms end 302. Apertures 308 extend from radially outward facing surface 306 to radially inward facing surface 314. Radially inward facing surface 316 is connected to radially inward facing surface 314 and extends therefrom in axial direction AD2. In an exemplary embodiment, the diameter of radially inward facing surface 314 is less than the diameter of radially inward facing surface 316.

Fingers 318 generally extend from end 304 and form radially outward facing surface 320 and radially inward facing surface 322. Radially outward facing surface 320 is connected to radially outward facing surface 310 and extends therefrom in axial direction AD2. In an exemplary embodiment, the diameter of radially outward facing surface 320 is greater than the diameter of radially outward facing surface 310. In such exemplary embodiment, and as shown, radially outward facing surface 320 is connected to radially outward facing surface 310 by surface 312. Surface 312 is an axial surface facing generally in direction AD1. In an exemplary embodiment, radially outward facing surface 320 comprises a constant diameter. In an exemplary embodiment, radially outward facing surface 320 comprises a variable diameter. For example, radially outward facing surface 320 may be a frusto-conical surface increasing in diameter in axial direction AD2. In an exemplary embodiment, the diameter of radially inward facing surface 322 is greater than the diameter of radially inward facing surface 316.

Fingers 318 further comprise end 324 and end 326. In such embodiments wherein retainer 300 comprises a plurality of fingers 318, fingers 318 are separated by circumferential spaces S3. Fingers 318 further comprise aperture 328 extending radially completely therethrough from radially outward facing surface 320 to radially inward facing surface 322. Aperture 328 forms one or more surfaces, for example surfaces 328A-328D. In an exemplary embodiment, surface 328A faces in axial direction AD1, surface 328C faces in axial direction AD2, surface 328B faces in circumferential direction CD1, and surface 328D faces in circumferential direction CD2. Tab or tongue 330 is arranged in aperture 328 such that it is fixedly secured at one end but spaced apart within aperture 328. For example, tongue 330 is fixedly secured to surface 328A but otherwise spaced apart from surfaces 328B-328D. This allows tongue 330 to pivot with respect to radially outward facing surface 320 in radial direction RD1 and radial direction RD2.

Tongue 330 comprises radially outward facing surface 330 and radially inward facing surface 334. In a rest or non-deformed position, radially outward facing surface 332 protrudes radially outward from radially outward facing surface 320 forming shoulder 334. Shoulder 334 faces substantially in axial direction AD2. Shoulder 334 is operatively arranged to engage groove 50 to connect retainer 300 to connector body 40, as will be described in greater detail below. In the non-deformed position, radially inward facing surface 334 extends radially inward from radially inward facing surface 322. In the non-deformed position, radially inward facing surface 334 is arranged at angle α with respect to radially inward facing surface 322 (similar to retainer 100 shown in FIG. 4). In an exemplary embodiment, angle α is an obtuse angle. In an exemplary embodiment, radially outward facing surface 332 is parallel to radially inward facing surface 334. In an exemplary embodiment, radially outward facing surface 332 is nonparallel to radially inward facing surface 334.

When retainer 300 is arranged in connector body 40 without tube 80, tongue 330 can be deformed radially inward in radial direction RD1 to disengage shoulder 334 from groove 50 such that retainer 300 can be removed from connector body 40. When retainer 300 and tube 80 are secured in connector body, tongue 330 can be deformed radially outward in radial direction RD2 to disengage shoulder 87 such that tube 80 can be removed from retainer 300. Retainer 300 can then be removed from connector body 40.

Seal 20 is overmolded onto retainer 300. In an exemplary embodiment, the elastomer is injection molded onto radially outward facing surface 306 and radially inward facing surface 314 such that it engages apertures 308. When the elastomer solidifies, seal 20 comprises radially inward facing surface 22 arranged radially inward of radially inward facing surface 316 and radially outward facing surface 28 arranged radially outward of radially outward facing surface 310. This allows seal 20 to perform sealing on two radial sides of retainer 300. For example, overmolded seal 20 facilitates a sealed connection between retainer 300 and connector body 40, and also between retainer 300 and tube 80. As such, overmolded seal 20 also creates a direct seal between tube 80 and connector body 40. In an exemplary embodiment, and as shown, seal 20 wraps around end 302.

To assemble the fluid connection assembly, retainer 300 is inserted into connector body 40 in axial direction AD1 with end 302 first. Due to the frusto-conical arrangement of tongues 330, as radially outward facing surfaces 332 engage radially inward facing surface 46 tongues 330 deflect radially inward in radial direction RD2. Once shoulders 334 are aligned with groove 50, tongues 330 displace radially outward in radial direction RD1 to their original non-deflected position. When retainer 300 is secured in connector body 40, seal 20 engages surface 58 and radially inward facing surface 56 providing a fluid tight connection between retainer 300 and connector body 40, radially outward facing surface 310 is engaged with radially inward facing surface 56, surface 312 is engaged with surface 52, shoulder 334 is engaged with groove 50, and radially outward facing surface 320 is engaged with radially inward facing surface 48.

Tube 80 is inserted into retainer 300 in axial direction AD1 with end 82 first. Shoulder 87 forces tongues 330 radially outward in radial direction RD1 (i.e., increasing angle α). Once shoulder 87 axially clears tongues 330, tongues 330 deflect back to their original position and engage surface 88. Shoulder 87 is then arranged axially between tongues 330 and surface 304, thereby securing tube 80 in retainer 300 and connector body 40. Radially outward facing surface 84 engages radially inward facing surface 60 and radially inward facing surface 316, and seal 20 engages radially outward facing surface 84 thereby creating a fluid tight seal between retainer 300 and tube 80.

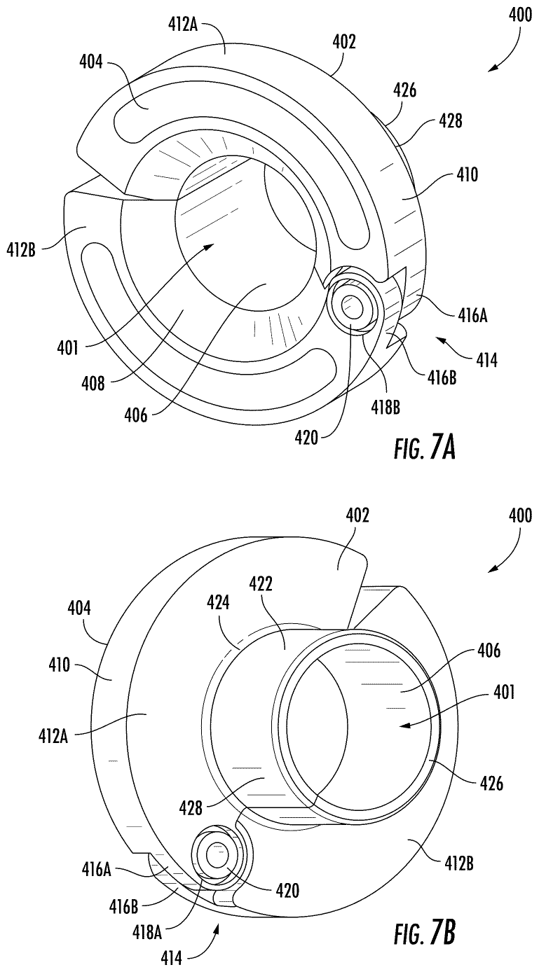

FIG. 7A is a front perspective view of disconnect tool 400 for fluid connection assembly 10. FIG. 7B is a rear perspective view of disconnect tool 400. Disconnect tool 400 generally comprises end 402, end 404, through-bore 401 forming radially inward facing surface 406, radially outward facing surface 410, and protrusion or nose 422. Nose 422 comprises end 424 connected to end 402, end 426, and radially outward facing surface 422. In an exemplary embodiment, tool 400 comprises section 412A and section 412B pivotably connected to section 412A, for example, via hinge 414. In such exemplary embodiment, section 412A comprises through-bore 418A, section 412B comprises through-bore 418B, and pin or bolt 420 engages through-bores 418A-418B to form hinge 414. In an exemplary embodiment, radially inward facing surface 406 is connected to end 404 via frusto-conical surface 408.

In order to disconnect tube 80 from connector body 40, tool 400 is pivoted open, arranged around section 89, and closed such that radially inward facing surface 406 engages radially outward facing surface 90 with nose 422 directed in axial direction AD1. Nose 422 is displaced in axial direction AD1 until it forces tongues 130, 230, 330 radially outward in radial direction RD1 such that they disengage shoulder 87. Then tube 80 and tool 400 are removed from retainer 100, 200, 300 and connector body 40.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

REFERENCE NUMERALS

| | |
|---|---|
| 10 | Fluid connection assembly |
| 20 | Seal |
| 21 | Through-hole |
| 22 | Radially inward facing surface |
| 24 | Protrusion or lobe |
| 26 | Protrusion or lobe |
| 28 | Radially outward facing surface |
| 30 | Protrusion or lobe |
| 32 | Protrusion or lobe |
| 40 | Connector body |
| 41 | Through-bore |
| 42 | End |
| 44 | End |
| 46 | Radially inward facing surface |
| 48 | Radially inward facing surface |
| 50 | Groove |
| 52 | Surface |
| 54 | Radially inward facing surface |
| 56 | Radially inward facing surface |
| 58 | Surface |
| 60 | Radially inward facing surface |
| 62 | Radially outward facing surface |
| 64 | Radially outward facing surface |
| 66 | Surface |
| 68 | Radially outward facing surface |
| 70 | Surface |
| 72 | Radially outward facing surface |
| 80 | Tube |
| 82 | End |
| 83 | Section |
| 84 | Radially outward facing surface |
| 86 | Surface |
| 87 | Shoulder or bead |
| 88 | Surface |
| 89 | Section |
| 90 | Radially outward facing surface |
| 92 | End |
| 94 | Through-bore |
| 100 | Retainer |
| 101 | Through-bore |
| 102 | End |
| 104 | End |
| 106 | Radially outward facing surface |
| 108 | Apertures |
| 110 | Radially outward facing surface |
| 112 | Surface |
| 114 | Radially inward facing surface |
| 116 | Radially inward facing surface |
| 118 | Fingers |
| 120 | Radially outward facing surface |
| 122 | Radially inward facing surface |
| 124 | End |
| 126 | End |
| 128 | Aperture |
| 128A | Surface |
| 128B | Surface |
| 128C | Surface |
| 128D | Surface |
| 130 | Tab or tongue |
| 132 | Radially outward facing surface |
| 134 | Shoulder or raised ledge |
| 136 | Radially inward facing surface |
| 138 | Arm |
| 140 | Projection |
| 142 | Channel |
| 200 | Retainer |
| 201 | Through-bore |
| 202 | End |
| 204 | End |
| 206 | Radially outward facing surface |
| 208 | Apertures |
| 212 | Surface |
| 214 | Radially inward facing surface |
| 218 | Fingers |
| 220 | Radially outward facing surface |
| 222 | Radially inward facing surface |
| 224 | End |
| 226 | End |
| 228 | Aperture |
| 228A | Surface |
| 228B | Surface |
| 228C | Surface |
| 228D | Surface |
| 230 | Tab or tongue |
| 232 | Radially outward facing surface |
| 234 | Shoulder or raised ledge |
| 236 | Radially inward facing surface |
| 238 | Arm |
| 240 | Projection |
| 242 | Channel |
| 300 | Retainer |
| 301 | Through-bore |
| 302 | End |
| 304 | End |
| 306 | Radially outward facing surface |
| 308 | Apertures |
| 310 | Radially outward facing surface |
| 312 | Surface |
| 314 | Radially inward facing surface |
| 316 | Radially inward facing surface |
| 318 | Fingers |
| 320 | Radially outward facing surface |
| 322 | Radially inward facing surface |
| 324 | End |
| 326 | End |
| 328 | Aperture |
| 328A | Surface |
| 328B | Surface |
| 328C | Surface |
| 328D | Surface |
| 330 | Tab or tongue |
| 332 | Radially outward facing surface |
| 334 | Shoulder or raised ledge |
| 336 | Radially inward facing surface |
| 400 | Disconnect tool |
| 401 | Through-bore |
| 402 | End |
| 404 | End |
| 406 | Radially inward facing surface |
| 408 | Radially inward facing surface |
| 410 | Radially outward facing surface |
| 412A | Section |
| 412B | Section |
| 414 | Hinge or pivot |
| 416A | Through-pole |
| 416B | Through-pole |
| 418A | Knuckle |
| 418B | Knuckle |
| 420 | Pin or bolt |
| 422 | Nose |
| 424 | End |
| 424 | End |
| 428 | Radially outward facing surface |
| AD1 | Axial direction |
| AD2 | Axial direction |
| CD1 | Circumferential direction |
| CD2 | Circumferential direction |
| RD1 | Radial direction |
| RD2 | Radial direction |
| S1 | Space |
| S2 | Space |
| S3 | Space |
| α | Angle |

What is claimed is:

1. A fluid connection assembly, comprising:
a connector body, including:
a first end;
a second end;
a first through-bore;
a first radially inward facing surface including a groove; and
a first radially outward facing surface; and
a retainer removably connectable to the connector body, including:
a second radially inward facing surface forming a third end and a fourth end;
a second radially outward facing surface;
a plurality of apertures extending radially from the second radially inward facing surface to the second radially outward facing surface; and
at least one finger extending from the fourth end; and
a seal overmolded onto the retainer.

2. The fluid connection assembly as recited in claim 1, wherein the apertures are circumferentially spaced.

3. The fluid connection assembly as recited in claim 1, wherein the seal:
extends through the plurality of apertures;
protrudes radially outward from the second radially outward facing surface; and
protrudes radially inward from the second radially inward facing surface.

4. The fluid connection assembly as recited in claim 1, wherein the seal creates a fluid tight connection between the retainer and the connector body.

5. The fluid connection assembly as recited in claim 1, wherein the seal wraps around the third end.

6. The fluid connection assembly as recited in claim 1, wherein the seal is arranged axially spaced apart from the third end.

7. The fluid connection assembly as recited in claim 1, wherein the at least one finger comprises a plurality of fingers circumferentially spaced.

8. The fluid connection assembly as recited in claim 1, wherein the at least one finger comprises:
a third radially outward facing surface;
a third radially inward facing surface; and
a through-hole extending radially from the third radially inward facing surface to the third radially outward facing surface.

9. The fluid connection assembly as recited in claim 8, wherein a tongue is arranged in the through-hole.

10. The fluid connection assembly as recited in claim 9, wherein the tongue forms a shoulder protruding radially outward from the third radially outward facing surface, the shoulder operatively arranged to engage the groove to secure the retainer to the connector body.

11. The fluid connection assembly as recited in claim 9, wherein the tongue protrudes radially inward from the third radially inward facing surface.

12. The fluid connection assembly as recited in claim 9, wherein the third radially outward facing surface comprises a constant diameter.

13. The fluid connection assembly as recited in claim 9, wherein the third radially outward facing surface is frusto-conical.

14. The fluid connection assembly as recited in claim 8, wherein the at least one finger further comprises:
an arm extending radially outward from the third radially outward facing surface; and
a projection extending axially from the arm and forming a channel between the projection and the third radially outward facing surface.

15. The fluid connection assembly as recited in claim 14, wherein the channel is operatively arranged to engage the second end.

16. A fluid connection assembly, comprising:
a connector body, including:
a first end;
a second end;
a first through-bore;
a first radially inward facing surface including a groove; and
a first radially outward facing surface; and
a retainer removably connectable to the connector body, including:
a second radially inward facing surface forming a third end and a fourth end;
a second radially outward facing surface;
a plurality of apertures extending radially from the second radially inward facing surface to the second radially outward facing surface; and
at least one finger extending from the fourth end; and
a seal overmolded onto the retainer to create a fluid tight connection between the retainer and the connector body, wherein the seal:
extends through the plurality of apertures;
protrudes radially outward from the second radially outward facing surface; and
protrudes radially inward from the second radially inward facing surface.

17. The fluid connection assembly as recited in claim 16, wherein the at least one finger comprises:
a third radially outward facing surface;
a third radially inward facing surface; and
a through-hole extending radially from the third radially inward facing surface to the third radially outward facing surface.

18. The fluid connection assembly as recited in claim 17, wherein a tongue is arranged in the through-hole.

19. The fluid connection assembly as recited in claim 18, wherein the tongue forms a shoulder protruding radially outward from the third radially outward facing surface, the shoulder operatively arranged to engage the groove to secure the retainer to the connector body.

20. The fluid connection assembly as recited in claim 18, wherein the tongue comprises a frusto-conical surface that protrudes radially inward from the third radially inward facing surface.
